(19) United States
(12) Patent Application Publication
(10) Pub. No.: US 2006/0128886 A1
(43) Pub. Date: Jun. 15, 2006

(54) Low-nitrogen content phenol-formaldehyde resin

(76) Inventor: Jack G. Winterowd, Puyallup, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/011,262

(22) Filed: Dec. 14, 2004

(51) Int. Cl. C08G 14/08

(52) U.S. Cl. 524/596

(57) ABSTRACT

A low-nitrogen content, high molecular weight, phenol-formaldehyde resin. The low-nitrogen content, high molecular weight, phenol-formaldehyde resin has a nitrogen content of from about 0 to 3%, is an aqueous solvent-free solution, has a molar ratio of formaldehyde to phenol of 1.2 to 3.0, a viscosity of less than about 500 cps at 20° C., an alkalinity level of about 5% to 15% and a percent solids of 10% to 60%.

### FIELD OF THE INVENTION

This invention generally relates to a low-nitrogen content phenol-formaldehyde resin. More specifically, this invention relates to a low-nitrogen content phenol-formaldehyde resin which when used in making engineered lignocellulosic-based panels produces low NO, emissions while at the same time delivers engineered lignocellulosic-based panels having good strength and dimensional stability.

### BACKGROUND OF THE INVENTION

Engineered lignocellulosic-based panels, such as oriented strandboard, high-density fiberboard, medium density fiberboard, chipboard, particleboard, hardboard, laminated-veneer lumber and plywood, are commonly used as roof, wall and floor sheathing in the construction of buildings and residential homes. A significant portion of this construction occurs outdoors at the building site. Thus, the engineered lignocellulosic-based panels are vulnerable for a period of time to rain or snow. It is well known that exposure to water can cause engineered lignocellulosic-based panels to undergo dimensional expansion. For instance, many engineered lignocellulosic-based panels will swell in thickness by a factor that is substantially greater than that experienced in the width and length dimensions and that swell is often inelastic in response to a wet/redry cycle. Thus, engineered lignocellulosic-based panels have a tendency to expand in thickness during their first exposure to water, and if the panel is later dried, the thickness dimension might decrease to some extent, but it does not return to its original value. Furthermore, the extent of residual swell can vary throughout the panel. Thus, the builder is faced with the dilemma of coping with roof, wall and floor surfaces that are geometrically irregular.

A second problem that often occurs when engineered lignocellulosic-based panels are exposed to water is a reduction in strength or structural load-carrying capacity. In addition to exposure to water during construction, exposure to water can also occur during occupancy of the structure. For example water can be introduced into the structure by wind-driven rain, which can be forced through leaks around various structure elements, such as doors, windows and roofs. Inadequate seals in water pipes can also cause engineered lignocellulosic-based panels to be exposed to water. Additionally, recent construction practices tend to result in buildings with reduced levels of ventilation. This condition can cause the accumulation of moisture inside of buildings, especially in wall cavities, crawl spaces and attics. The ability of the engineered lignocellulosic-based panels to withstand these insults for some extended period of time without significant loss of structural properties or the development of mold or incipient decay is an important quality.

Companies that manufacture engineered lignocellulosic-based panels have recognized the problems associated with exposure to water for many years. In an effort to improve the properties of engineered lignocellulosic-based panels in a wet environment a number of technologies have been developed and implemented. For instance, wax is typically incorporated into engineered lignocellulosic-based panels in order to retard the penetration of water. Also, most engineered lignocellulosic-based panels are treated on the edges with a sealant, which helps the panel to resist the absorption of water at the edges where thickness swell is most prominent and problematic.

It is generally believed that many of the properties associated with engineered lignocellulosic-based panels could be improved if higher binder levels were used. Unfortunately, a variety of constraints make it difficult for engineered lignocellulosic-based panel manufacturers to utilize higher binder levels.

To overcome these problems U.S. Pat. No. 3,632,734 described a non-conventional method for manufacturing engineered lignocellulosic-based panels. This patent describes a method for reducing swelling in engineered lignocellulosic-based panels that is based on the following key steps: a phenol-formaldehyde impregnating resin is applied to green wood particles at a level of about 4-8%; the treated green wood particles are dried under temperature conditions that avoided pre-cure of the impregnating resin; a phenol-formaldehyde resin binder is then applied to the dried wood particles at a level of about 4-8%; and the treated particles are formed into a mat and subjected to heat and pressure to form a panel and cure the resins. Unfortunately, these phenolic impregnating resins tend to emit significant levels of organic volatile emissions such as phenol, formaldehyde and low molecular weight phenol/formaldehyde adducts when subjected to drying conditions. Thus, current regulatory requirements would prevent a manufacturer from applying this type of phenolic impregnating resin to green wood particles on a commercial scale.

Conversely, phenolic bonding resins , which have larger monomers and therefore are less volatile and less likely to emit organic emissions, contain significant levels of urea or some other nitrogen-based compound, such as the cyclic urea prepolymers described in U.S. Pat. No. 6,369,171 B2. These compounds are typically added to the phenolic bonding resin in an attempt to consume residual, unreacted formaldehyde, which commonly exists in the resin. The addition of urea and other nitrogen-based compounds to phenolic bonding resins also serves to lower the viscosity of the resin, which is of vital importance because these resins are applied to the strands by use of spray or atomization techniques that all require low viscosity values (generally less than about 500 cps when measured by use of Gardner-Holdt bubble tubes).

Unfortunately, we have discovered that when conventional liquid phenolic bonding resins are applied to green strands and the treated strands are dried at elevated temperatures, significant levels of ammonia are liberated. Although ammonia is not heavily regulated, the ammonia can be converted to nitrogen monoxide, nitrogen dioxide, or other NO, type compounds if it is processed through a pollution control device known as a Regenerative Thermal Oxidizer (RTO). Such devices are commonly attached to dryers in OSB mills. There are regulatory limitations associated with such NOₓ emissions.

More recently, U.S. Pat. No. 6,572,804 discloses the application of a phenol-formaldehyde resin to green strands and subsequent drying of the strands in the presence of methyol urea. The dry treated strands are optionally blended with more binder and are eventually consolidated under heat and pressure to yield a building panel. The patent discloses a new phenol-formaldehyde resin binder that is produced by adding urea to a liquid phenol-formaldehyde resin and subsequently adding formaldehyde to the same resin in order to convert the free urea into methyol urea. The patent claims that the new phenol-formaldehyde resin binder is less likely to emit ammonia than a conventional phenol-formaldehyde resin binder that was made with only a post addition of urea. Unfortunately, we have evaluated this resin in the laboratory and have discovered that the methyol urea adduct emits significant levels of both ammonia and formaldehyde when it is heated to elevated temperatures, such as those that are expected of a strand as it is being processed in a dryer.

Thus, there continues to be a need for engineered lignocellulosic-based panels with improved performance in the presence of water. It is recognized that such a panel could be made by use of “green-strand-blending”. However, in order to satisfy emission requirements, the resin used in the green-strand-blending process must not emit significant levels of ammonia or volatile organic compounds, including formaldehyde, phenol and methanol.

### SUMMARY OF THE INVENTION

The present invention provides a low-nitrogen content, high molecular weight, phenol-formaldehyde resin as an aqueous, solvent-free solution with a molar ratio of formaldehyde to phenol of 1.2 to 3.0, a viscosity value less than about 500 cps, an alkalinity level of 5% to 15% and a percent solids level of 10% to 60%. This phenol-formaldehyde resin emits low levels of volatile compounds, including ammonia, and can be applied to green strands and dried without significantly increasing NO, emissions.

### DETAILED DESCRIPTION OF THE INVENTION

In accordance with the present invention there is provided a low-nitrogen content, high molecular weight, phenol-formaldehyde resin as an aqueous, solvent-free solution with a molar ratio of formaldehyde to phenol of 1.2 to 3.0, a viscosity value less than about 500 cps, an alkalinity level of 5% to 15% and a percent solids level of 10% to 60% for use to manufacture engineered lignocellulosic-based panels. The lignocellulosic-based panels are produced from green lignocellulosic particles. The term “green lignocellulosic particles” means that the particles are obtained from undried wood and generally have a moisture content of 30% to 200%, where moisture content equals 100% x (water mass in the wood)/(dry wood mass). Generally, most logs delivered to a commercial mill would have such a moisture content. Other ways to obtain such a moisture content are to use logs of wood that were placed in a vat or hot pond when they entered the manufacturing facility to help thaw the wood and/or remove dirt and grit from the logs. Thus, it is within the scope of this invention to use wooden logs that have never been dried below a moisture content of 30%, or alternatively, to use wooden logs that have been dried to a moisture content of less than 30% and have then been rehydrated to a moisture content of greater than 30%. Debarked logs are then run through a flaker to provide particles having certain properties, such as specific length, width and thickness. In a conventional OSB manufacturing process, green logs are debarked and then cut into strands, which on average can be about 1 to 14 inches long, preferably 3 to 9 inches long, about 0.25 to 2 inches wide, and about 0.01 to 0.10 inches thick. The use of a peeler to form discrete layers or plys useful in manufacturing plywood or composite products, such as laminated veneer lumber, can be substituted for a flaker and is within the scope of the invention.

The machines that are used to cut the particles work best on relatively wet wood. Thus, the relatively large sections of wood that are utilized by the particle-cutting machines usually have a moisture content of 30 to 200 percent. Typically, the green lignocellulosic particles are stored in a green bin or wet bin before drying to specified manufacturing moisture content.

A first resin is added to the green lignocellulosic particles before the green particles are dried. The first resin is added in an amount from about 1 to 25 weight percent based on the solids weight of the resin and the dry weight of the particles. More preferably, from about 5 to 15 weight percent based on the solids weight of the resin and the dry weight of the particles. The first resin is a low nitrogen content, high molecular weight, phenol-formaldehyde resin as an aqueous, solvent-free, solution with a molar ratio of formaldehyde to phenol of 1.2 to 3.0, a viscosity value less than about 500 cps, an alkalinity level of 5% to 15% and a percent solids level of 10% to 60%.

Optionally, wax may be added to the green lignocellulosic particles with the first resin. Waxes suitable for the present invention are usually hydrocarbon mixtures derived from a petroleum refining process. They are utilized in order to impede the absorption of water, and thus make the product more dimensionally stable in a wet environment for some limited period of time. These hydrocarbon mixtures are insoluble in water and have a melting point that is commonly between 35° to 70° C. Hydrocarbon waxes obtained from petroleum are typically categorized on the basis of their oil content. “Slack wax”, “scale wax”, and “fully refined wax” have oil content values of 2% to 30%, 1% to 2% and 0% to 1%, respectively. Although high oil content is generally believed to have an adverse effect on the performance of a wax, slack wax is less expensive than the other petroleum wax types, and is thus used almost exclusively in engineered panels. Alternatively, waxes suitable for the present invention can be any substance or mixture that is insoluble in water and has a melting point between about 35° to 120° C. It is also desirable for the wax to have low vapor pressure at temperatures between about 35° to 200° C. An example of such a wax, and is not derived from petroleum, is known as NaturaShield, which is a wax derived from agricultural crops and made available to the engineered panel industry by Archer Daniels Midland [Mankato, Minn.]. The wax, if added, would be in an amount of from about 0.25 to 3 percent (based on the solids weight of the wax and the dry weight of the particles). Although wax can be added at this point in the process it is preferred that the wax be added after the drying stage as discussed below.

For the purpose of this invention the term “high molecular weight” means that about 12% to 35% of the solute portion of the phenol-formaldehyde resin will not spontaneously diffuse through a dialysis membrane tube comprised of regenerated cellulose and having a known molecular weight cut-off of 3,500 Da when said membrane tube is immersed in a continuously stirred reservoir of 50/50 wt/wt methanol/water solution at a temperature of 20° C. for a period of five days. This test for the high molecular weight content of a resin specifically involves diluting a resin specimen (10.0 g) with a 50/50 wt/wt methanol/water solution (40.0 g) and then transferring a portion of this solution (40.0 g) into a preconditioned dialysis membrane tube (3,500 Da MWCO, 30 cm length and 29 mm diameter), which has been clamped on one end. The membrane is preconditioned by soaking in the 50/50 wt/wt methanol/water solution for a period of at least 30 minutes at a temperature of about 20° C. The dialysis membranes are known in the art. One such membrane is commercially manufactured and sold under the trade name Spectra/Por by Spectrum Laboratory Products, Inc. [New Brunswick, N.J.]. The dialysis membrane tube, which has been loaded with a diluted resin sample, is then clamped on the open end and submerged in a reservoir of 50/50 wt/wt methanol/water solution (1750 mL). The reservoir fluid is continuously stirred and maintained at a temperature of 20° C. for a period of one day. This initial charge of reservoir fluid is then separated from the loaded dialysis tube and discarded. The loaded dialysis tube is then immersed in a fresh aliquot of 50/50 wt/wt methanol/water solution (1750 mL). This second aliquot of reservoir fluid is continuously stirred and maintained at a temperature of 20° C. for a period of three additional days. This second aliquot of reservoir fluid is then separated from the loaded dialysis tube and discarded. The loaded dialysis tube is then immersed in another fresh aliquot of 50/50 wt/wt methanol/water solution (1750 mL). This third aliquot of reservoir fluid is continuously stirred and maintained at a temperature of 20° C. for a period of one additional day. At the end of the fifth day the contents of the loaded tube are transferred into a secondary container and accurately weighed. The dialyzed residue is then filtered through pre-weighed GF/B Glass Microfibre Filters by Whatman International Ltd [Maidstone, England]. The filter plus any resin precipitate is then dried for 2 hours at 105° C. and then weighed in order to determine the dry mass of any precipitate that formed in the resin during the dialysis process. The percent solids value of the filtered, dialyzed resin residue is then determined by drying a portion of this material (about 5 g) for 2 hours at 105° C. and this value can be multiplied by the total mass of retained resin in order to determine the total mass of retained “soluble” resin solids. The total mass of retained soluble resin solids can then be added to the dry precipitate mass in order to determine the total mass of “retained” soluble and insoluble resin solids. This value can be compared to the mass of resin solids that was initially loaded into the dialysis membrane in order to determine a value for the percent of retained solids material.

It should be noted that resins described in this invention have essentially no precipitate formation when subjected to this dialysis test, however, precipitate formation has been observed when this test method was conducted on other resins.

In a broad embodiment of the invention the phenolic resin is a solution, free of volatile solvents, has a nitrogen content of from about 0 to 3%, preferably from about 0 to 1%; a molar ratio of formaldehyde to phenol of 1.2 to 3.0, preferably 1.2 to 1.6; a high molecular weight content (as determined by dialysis) of about 12% to 35%, preferably from about 15% to 32%; a viscosity of about 20 to 500 cps at 20° C., preferably from about 50 to 300 cps; an alkalinity value of about 5% to 15%, preferably from about 6% to 13%; and a percent solids value of from about 10% to 60%, preferably from about 20% to 55%.

Volatile solvents are deliberately added to some types of phenolic resins, especially those used for paper saturating applications. These solvents include, but are not limited to, methanol, isopropyl alcohol, ethanol, acetone, and methyl ethyl ketone. Resins made with the deliberate addition of these volatile solvents would render the resin unsuitable for the intended application.

The nitrogen content of the phenolic resin will be influenced by any compound added to the resin that contains nitrogen. Such compounds include, but are not limited to, urea, urea/formaldehyde adducts, cyclic urea prepolymers (such as those described in U.S. Pat. No. 6,369,171 B2), triethanolamine, melamine, other nitrogen-based heterocyclic compounds (such as pyridine, pyridine adducts, morpholine, and morpholine adducts), aliphatic amines (such as hexamethylene diamine), various amino acids, proteins, or any other compound that contains nitrogen and is soluble in the resin.

The molar ratio of formaldehyde to phenol is determined by dividing the total number of moles of formaldehyde added to the resin at any point in the synthesis process by the total number of moles of phenol added to the resin at any point in the process. The invented resin is a resole and not a novolak.

For the purpose of this invention the high molecular weight content will be determined by the dialysis technique that was previously described. In general higher levels of high molecular weight material in the resin tend to yield stronger, more durable strand-to-strand bonds when the resin of the present invention is applied to green strands.

For the purpose of this invention viscosity values are determined by multiplying resin density (expressed in g/mL) by the kinematic viscosity value (expressed in centistokes) obtained by use of Gardner-Holdt bubble tubes at a temperature of 25° C. Bubble tube standards are commercially available from Paul N. Gardner Company, Incorporated [Pompano Beach, Fla.].

For the purpose of this invention the alkalinity value is defined as 100%×(total solids mass of alkaline substance)/(total solids mass of the resin). Alkaline substances suitable for this invention include sodium hydroxide, sodium carbonate, potassium hydroxide, potassium carbonate and limited amounts basic amines, such as triethanolamine, diethanolamine and ethanolamine. It must be stressed that the alkalinity value is not the pH value, and the relationship between these two parameters is proportional, but certainly not linear. Typically, the resins will have pH values between about 8 and 13.

For the purpose of this invention the percent solids value of a resin is based on the loss in mass that occurs when a sample of resin (ca. 1.0 g) is accurately weighed into a small aluminum pan (about 5 cm in diameter with a 2 cm lip) and dried for a period of 2 hours at a temperature of 105° C. in a ventilated oven. Subsequent to the drying process the mass of the resin residue is obtained through accurate measurements. The percent solids value is equal to 100%×(residue mass)/(original total wet mass).

The resin is typically made by charging a reactor vessel with a mixture of phenol, formaldehyde, water and an initial small charge of an alkaline substance. The amount of alkaline substance must be sufficient to result in a pH value of about 8 to 8.5. The molar ratio of formaldehyde to phenol should be in the range 1.2 to 2.0. The phenol can be added in the form of solid crystals or molten liquid or an aqueous solution. The formaldehyde can be added as an aqueous solution or as paraformaldehyde prill. The mixture is stirred and heated to a temperature of about 70° to 90° C. and maintained at this temperature until the mixture is a single phase, solution with a viscosity of about 30 cps. At this point a second small charge of alkaline substance is added which should be sufficient to increase the pH level to about 8.5 to 9.0. The temperature should be maintained between about 70° to 90° C. until the viscosity is about 40 to 100 cps. At this point the mixture can be cooled to 20° C. and combined with a final charge of alkaline substance, or alternatively, it can be maintained at a temperature of 70° to 90° C. and subjected to cycles involving the addition of alkaline substance and water and continued stirring at elevated temperatures between 70° to 90° C. until a desired content of high molecular weight material is achieved in the resin. Ultimately, the resin will be cooled to 20° C. and combined with a final charge of alkaline substance and/or water. In all cases the resulting resin must be a solution, free of volatile solvents, have a nitrogen content of from about 0 to 3%, preferably from about 0 to 1%; a molar ratio of formaldehyde to phenol of 1.2 to 2.0, preferably 1.2 to 1.6; a high molecular weight content (as determined by dialysis) of about 12% to 35%, preferably from about 15% to 32%; a viscosity of about 20 to 500 cps at 20° C., preferably from about 50 to 300 cps; an alkalinity value of about 5% to 15%, preferably from about 6% to 13%; and a percent solids value of from about 10% to 60%, preferably from about 20% to 55%.

In its intended application the resin of the present invention will be applied to the green lignocellulosic particles before the particles are dried. Examples of application locations in an OSB mill include before the drier, after, or in, the green or wet bin, between the green or wet bin and flaker or peeler, at the exit of the flaker or peeler, and even in the hot pond, or treatment vat for treating logs (either debarked or whole). Resin application can be by spray nozzles or through a conventional spinner disc atomizer. Though less effective than applying the resin to the green lignocellulosic particles whose surface area has already been increased (e.g., by flaking or peeling), the invention is also applicable to all phases of board preparation, provided that at least some resin is applied upstream of the drier.

The green lignocellulosic particles thereafter are sent to dryers to dry the lignocellulosic particles to a moisture content of about 1 to 10%, preferably 1 to 3 wt percent. Dried lignocellulosic particles are stored in dry bins until blended with resin binders, waxes and possibly other conventional additives.

Blending is where resin binder and wax (emulsion or slack) are typically added to the dried lignocellulosic particles. The resin binder is typically a phenol-formaldehyde (PF) resole resin such as Georgia Pacific's 70CR66 (liquid) and Dynea's 2102-83 (powdered); or polymeric diphenylmethane diisocyanate (pMDI) such as Huntsman's Rubinate® 1840. Resin binders are typically applied at rates between about 1% to about 8.0% (based on a wt % of solid binder to oven-dry wood). More preferably, at a level of about 2 to 6%. The wax, if added, would be as described above with regard to the first resin applied prior to drying. The wax would be applied in an amount of from about 0.25 to 3 percent (based on a wt % of solid binder to oven-dry wood), preferably from 1 to 2%. Examples of suitable waxes include ESSO 778 (ExxonMobil) and Borden's EW-465.

The blended lignocellulosic particles are transferred to forming bins, which are used to meter the lignocellulosic particles onto a forming surface, such as a forming belt. The forming bins contain orienter rolls or discs, which orient the flakes in either the direction of the forming line or transverse to the direction of forming line, travel. The forming bins also control the amount of lignocellulosic particles falling onto the forming surface, which controls the finished panel density, which is usually between about 36 and 50 pounds per cubic foot.

In some engineered panels, some of the lignocellulosic particles prepared are destined for the top and bottom layers of the panel and these lignocellulosic particles are known as surface-layer particles. Other particles are destined for the middle layer or layers of the engineered panel and these particles are known as core-layer particles. The surface-layer particles are treated with surface-layer binder resin and wax. Likewise, the core-layer particles are treated with core-layer binding resin and wax. In many cases the surface-layer binder resin is different than the core-layer binder resin. The treated particles are then formed into a mat that is comprised of three or more layers. In most cases the surface-layer particles in the mat are partially oriented parallel to the machine direction of the forming line. Conversely, the core-layer particles in the mat are generally partially oriented parallel to the cross direction of the forming line, although they can also be partially oriented parallel to the machine direction of the forming line or randomly oriented.

The forming surface travels under forming heads creating a continuous mat of particles. These mats are typically cut to specific lengths and loaded onto a pre-loader or loading cage that is a staging area for a full press-load of mats.

The invention has applicability to all known board manufacturing processes, including those using heated press platens, steam injection, catalyst injection, microwave or radio-frequency (RF), heating and continuous and semi-batch pressing operations.

As an illustration, when using heated press platens, the mat is placed between two hot platens and subjected to heat and pressure. The temperature of the hot platens can be from 300° F. to 460° F., preferably from about 380 to 430° F. As the platens in the press begin to close on the mat, the pressure increases to a maximum of about 500-800 psi, and maximum pressure generally occurs when the platens initially reach the point of maximum closure. Typically, the platens are maintained in this position of maximum closure for a period of time that is required to cure the resin binder. Sometimes this period is known as the “cook-time” or “hold-time”. During this pressing process adjacent particles are consolidated and become joined together as the different binder resins solidify. Generally, the temperature and moisture content of the portion of the consolidated mat that is nearest to the top and bottom hot platens is sufficient to plasticize the lignin in the particles, and the force of the platens is sufficient to compress the native structure of the lignocellulosic particles. Thus, the density of the outer layers of the compressed mat is usually significantly higher than the density of the original lignocellulosic particles. Eventually the pressure is relieved from the consolidated mat by increasing the gap between the top and bottom platens. As this occurs, the strength of the particle-to-particle bonds exceeds any internal pressure that might exist within the mat. Internal pressure commonly exists due to the presence of steam, which becomes trapped within the mat. If the internal steam pressure exceeds the strength of the particle-to-particle bonds in some localized area, then the board will rupture or explode as the press opens. The internal steam pressure that develops in the compressed mat is generally closely related to the moisture content that existed in the mat just prior to pressing.

The conditions of elevated temperature, pressure, and time can be varied to control the cure time. Catalyst can also be introduced during the processing steps to optimize the pressing times or to shorten the overall pressing time. The finished panels are thereafter usually cut to size, stacked, painted and packaged for delivery to the customer.

The resulting engineered lignocellulosic-based panels have improved dimensional stability and strength properties, while simultaneously avoiding a significant increase in ammonia and/or NO, emissions and with minimal increase in organic emissions during processing.

The invention is further illustrated by the following examples: Resin A

A phenol-formaldehyde resin was prepared in the following manner. A 2 liter reactor was charged with a 90% phenol solution (aq) (626.4 g; 6.0 moles) [from Spectrum Chemical Manufacturing Corporation; New Brunswick, N.J.], 91% paraformaldehyde prill (330.0 g; 10.0 moles) [from the Ashland Distribution Company; Columbus, Ohio], water (600.0 g) and 50% sodium hydroxide solution (aq) (10.0 g) [from the Integra Chemical Company; Renton, Wash.]. The mixture was stirred and heated to a temperature of 85° C. over a period of 20 minutes. The temperature was maintained at 85° C. until the viscosity of the mixture was an ‘A’ as determined by Gardner-Holdt bubble tubes at a temperature of 20° C. A charge of 50% sodium hydroxide solution (aq) (10.0 g) was then added to the reactor and the temperature was reduced to 80° C. The temperature was maintained at 80° C. until the viscosity of the mixture was an ‘H’ as determined by Gardner-Holdt bubble tubes at a temperature of 20° C. The mixture was then cooled to a temperature of 20° C. and a final charge of 50% sodium hydroxide solution (aq) (200.0 g) was added to the reactor with continued stirring. The resulting resin was a clear solution free of volatile solvents. It had a nitrogen content of 0%, a molar ratio of formaldehyde to phenol of 1.67, a high molecular weight content of 15.5%, a density of 1.18 g/mL, a viscosity value of 132 cps, an alkalinity value of 12.2%, a pH value of 11, and a percent solids value of 50.8%.

### Resin B

A phenol-formaldehyde resin was prepared in the following manner. A 2 liter reactor was charged with a 90% phenol solution (aq) (626.4 g; 6.0 moles) [from Spectrum Chemical Manufacturing Corporation; New Brunswick, N.J.], 37% formalin (729.0 g; 9.0 moles) [from the Integra Chemical Company; Renton, Wash.], and 50% sodium hydroxide solution (aq) (10.0 g) [from the Integra Chemical Company; Renton, Wash.]. The mixture was stirred and heated to a temperature of 85° C. over a period of 20 minutes. The temperature was maintained at 85° C. until the viscosity of the mixture was an ‘A’ as determined by Gardner-Holdt bubble tubes at a temperature of 20° C. A charge of 50% sodium hydroxide solution (aq) (10.0 g) was then added to the reactor and the temperature was reduced to 80° C. The temperature was maintained at 80° C. until the viscosity of the mixture was an ‘H’ as determined by Gardner-Holdt bubble tubes at a temperature of 20° C. The mixture was then cooled to a temperature of 20° C. and a final charge of 50% sodium hydroxide solution (aq) (210.0 g) was added to the reactor with continued stirring. The resulting resin was a clear solution free of volatile solvents. It had a nitrogen content of 0%, a molar ratio of formaldehyde to phenol of 1.50, a high molecular weight content of 23.3%, a density of 1.20 g/mL, a viscosity value of 278 cps, an alkalinity value of 13.0%, a pH value of 11, and a percent solids value of 56.0%.

### Resin C

A phenol-formaldehyde resin was prepared in the following manner. A 2 liter reactor was charged with a 90% phenol solution (aq) (626.4 g; 6.0 moles) [from Spectrum Chemical Manufacturing Corporation; New Brunswick N.J.], 91% paraformaldehyde prill (270.0 g; 8.2 moles) [from Spectrum Chemical Manufacturing Corporation; New Brunswick, N.J.], water (270.0 g) and 50% sodium hydroxide solution (aq) (10.0 g) [from the Integra Chemical Company; Renton, Wash.]. The mixture was stirred and heated to a temperature of 85° C. over a period of 20 minutes. The temperature was maintained at 85° C. until the viscosity of the mixture was an ‘A’ as determined by Gardner-Holdt bubble tubes at a temperature of 20° C. A charge of 50% sodium hydroxide solution (aq) (10.0 g) was then added to the reactor and the temperature was reduced to 80° C. The temperature was maintained at 80° C. until the viscosity of the mixture was an ‘H’ as determined by Gardner-Holdt bubble tubes at a temperature of 20° C. A charge of 50% sodium hydroxide solution (aq) (30.0 g) and water (500 g) was then added to the reactor and the temperature was adjusted to 80° C. The temperature was maintained at 80° C. until the viscosity of the mixture was an ‘F’ as determined by Gardner-Holdt bubble tubes at a temperature of 20° C. The mixture was then cooled to a temperature of 20° C. and a final charge of 50% sodium hydroxide solution (aq) (50.0 g) was added to the reactor with continued stirring. The resulting resin was a clear solution free of volatile solvents. It had a nitrogen content of 0%, a molar ratio of formaldehyde to phenol of 1.37, a high molecular weight content of 18.9%, a density of 1.15 g/mL, a viscosity value of 129 cps, an alkalinity value of 6.3%, a pH value of 11, and a percent solids value of 45.1%.

### Resin D

A 20-liter reactor, which was equipped with heating jacket, cooling coils and reflux condenser, was charged with 90% phenol solution (aq) (50.8 moles, 5,306 g), 91% paraformaldehyde prill (76.5 moles, 2,523 g), water (4,125 g) and 50% sodium hydroxide solution (aq) (79.2 g). The mixture was stirred and heated to a temperature of 85° C. over a period of 115 minutes. The temperature of the mixture was maintained at 85° C. until the viscosity was an ‘A2’ as determined by use of Gardner-Holdt bubble tubes at a temperature of 20° C. At this point a second charge of 50% sodium hydroxide solution (aq) (79.2 g) was added to the reactor and the temperature of the mixture was reduced to 80° C.

The mixture was stirred and the temperature was maintained at 80° C. until the viscosity was an ‘B’ as determined by use of Gardner-Holdt bubble tubes at a temperature of 20° C. At this point a charge of 50% sodium hydroxide solution (aq) (165.0 g) and hot water (4,191 g) were added to the reactor with continuous stirring.

The temperature of the mixture was adjusted to 75° C. and maintained at this level until the viscosity was a ‘J’ as determined by use of Gardner-Holdt bubble tubes at a temperature of 20° C. At this point a charge of 50% sodium hydroxide solution (aq) (330.0 g) and hot water (4,191 g) were added to the reactor with continuous stirring.

Again, the temperature of the mixture was adjusted to 75° C. and maintained at this level until the viscosity was a ‘J’ as determined by use of Gardner-Holdt bubble tubes at a temperatures of 20° C. At this point the mixture was cooled to a temperature of 20° C. and a charge of 50% sodium hydroxide solution (aq) (468.6 g) was added to the reactor with continuous stirring.

The resulting resin was a clear solution free of volatile solvents. It had a nitrogen content of 0%, a molar ratio of formaldehyde to phenol of 1.51, a high molecular weight content of 30.8%, a density of 1.11 g/mL, a viscosity value of 89 cps, an alkalinity value of 8.5%, a pH value of 11, and a percent solids value of 30.9%.

### Resin E

A phenol-formaldehyde resin was prepared in the following manner. A 4 liter reactor was charged with a 90% phenol solution (aq) (803.9 g; 7.7 moles) [from Spectrum Chemical Manufacturing Corporation; New Brunswick, N.J.], 91% paraformaldehyde prill (382.4 g; 11.6 moles) [from Spectrum Chemical Manufacturing Corporation; New Brunswick, N.J.], water (625.0 g) and 50% sodium hydroxide solution (aq) (12.0 g) [from the Integra Chemical Company; Renton, Wash.]. The mixture was stirred and heated to a temperature of 85° C. over a period of 20 minutes. The temperature was maintained at 85° C. until the viscosity of the mixture was an ‘A2’ as determined by Gardner-Holdt bubble tubes at a temperature of 20° C. A charge of 50% sodium hydroxide solution (aq) (12.0 g) was then added to the reactor and the temperature was reduced to 80° C. The temperature was maintained at 80° C. until the viscosity of the mixture was a ‘B’ as determined by Gardner-Holdt bubble tubes at a temperature of 20° C. A charge of 50% sodium hydroxide solution (aq) (25.0 g) and water (635.0 g) was then added to the reactor and the temperature was adjusted to 75° C. The temperature was maintained at 75° C. until the viscosity of the mixture was an ‘J’ as determined by Gardner-Holdt bubble tubes at a temperature of 20° C. A charge of 50% sodium hydroxide solution (aq) (50.0 g) and water (635.0 g) was then added to the reactor and the temperature was adjusted to 75° C. The temperature was maintained at 75° C. until the viscosity of the mixture was an ‘J’ as determined by Gardner-Holdt bubble tubes at a temperature of 20° C. The mixture was then cooled to a temperature of 20° C. and a final charge of 50% sodium hydroxide solution (aq) (71.0 g) was added to the reactor with continued stirring. The resulting resin was a clear solution free of volatile solvents. It had a nitrogen content of 0%, a molar ratio of formaldehyde to phenol of 1.50, a density of 1.10 g/mL, a viscosity value of 77 cps, an alkalinity value of 8.7%, a pH value of 11, and a percent solids value of 30.1%.

### Resin F

A 2-liter reactor, which was equipped with heating jacket, cooling coils and reflux condenser, was charged with 90% phenol solution (aq) (7.7 moles, 803.9 g), 91% paraformaldehyde prill (11.6 moles, 382.4 g), water (200.0 g) and 50% sodium hydroxide solution (aq) (12.0 g). The mixture was stirred and heated to a temperature of 85° C. over a peiod of 20 minutes. The temperature of the mixture was maintained at 85° C. until the viscosity was an ‘A2’ as determined by use of Gardner-Holdt bubble tubes at a temperature of 20° C. At this point a second charge of 50% sodium hydroxide solution (aq) (12.0 g) was added to the reactor and the temperature of the mixture was reduced to 80° C.

The mixture was stirred and the temperature was maintained at 80° C. until the viscosity was an ‘B’ as determined by use of Gardner-Holdt bubble tubes at a temperature of 20° C. At this point a charge of 50% sodium hydroxide solution (aq) (12.0 g) and water (210.0 g) were added to the reactor with continuous stirring.

The temperature of the mixture was adjusted to 75° C. and maintained at this level until the viscosity was a ‘J’ as determined by use of Gardner-Holdt bubble tubes at a temperature of 20° C. At this point a charge of 50% sodium hydroxide solution (aq) (12.0 g) and water (210.0 g) were added to the reactor with continuous stirring.

Again, the temperature of the mixture was adjusted to 75° C. and maintained at this level until the viscosity was a ‘J’ as determined by use of Gardner-Holdt bubble tubes at a temperature of 20° C. At this point the mixture was cooled to a temperature of 20° C. and a charge of 50% sodium hydroxide solution (aq) (122.0 g) was added to the reactor with continuous stirring.

The resulting resin was a clear solution free of volatile solvents. It had a nitrogen content of 0%, a molar ratio of formaldehyde to phenol of 1.50, a density of 1.18 g/mL, a viscosity value of 195 cps, an alkalinity value of 8.6%, a pH value of 11, and a percent solids value of 49.9%.

### Resin G

A 2-liter reactor, which was equipped with heating jacket, cooling coils and reflux condenser, was charged with 90% phenol solution (aq) (7.7 moles, 803.9 g), 91% paraformaldehyde prill (11.6 moles, 382.4 g), water (200.0 g) and 50% sodium hydroxide solution (aq) (12.0 g). The mixture was stirred and heated to a temperature of 85° C. over a period of 20 minutes. The temperature of the mixture was maintained at 85° C. until the viscosity was an ‘A2’ as determined by use of Gardner-Holdt bubble tubes at a temperature of 20° C. At this point a second charge of 50% sodium hydroxide solution (aq) (12.0 g) was added to the reactor and the temperature of the mixture was reduced to 80° C.

The mixture was stirred and the temperature was maintained at 80° C. until the viscosity was an ‘B’ as determined by use of Gardner-Holdt bubble tubes at a temperature of 20° C. At this point a charge of 50% sodium hydroxide solution (aq) (12.0 g) and water (454.0 g) were added to the reactor with continuous stirring.

The temperature of the mixture was adjusted to 75° C. and maintained at this level until the viscosity was a ‘J’ as determined by use of Gardner-Holdt bubble tubes at a temperature of 20° C. At this point a charge of 50% sodium hydroxide solution (aq) (12.0 g) and water (454.0 g) were added to the reactor with continuous stirring.

Again, the temperature of the mixture was adjusted to 75° C. and maintained at this level until the viscosity was a ‘J’ as determined by use of Gardner-Holdt bubble tubes at a temperature of 20° C. At this point the mixture was cooled to a temperature of 20° C. and a charge of 50% sodium hydroxide solution (aq) (122.0 g) was added to the reactor with continuous stirring.

The resulting resin was a clear solution free of volatile solvents. It had a nitrogen content of 0%, a molar ratio of formaldehyde to phenol of 1.50, a density of 1.15 g/mL, a viscosity value of 98 cps, an alkalinity value of 8.6%, a pH value of 11, and a percent solids value of 39.8%.

### Resin H

A 2-liter reactor, which was equipped with heating jacket, cooling coils and reflux condenser, was charged with 90% phenol solution (aq) (7.7 moles, 803.9 g), 91% paraformaldehyde prill (11.6 moles, 382.4 g), water (625.0 g) and 50% sodium hydroxide solution (aq) (12.0 g). The mixture was stirred and heated to a temperature of 85° C. over a period of 20 minutes. The temperature of the mixture was maintained at 85° C. until the viscosity was an ‘A2’ as determined by use of Gardner-Holdt bubble tubes at a temperature of 20° C. At this point a second charge of 50% sodium hydroxide solution (aq) (12.0 g) was added to the reactor and the temperature of the mixture was reduced to 80° C.

The mixture was stirred and the temperature was maintained at 80° C. until the viscosity was an ‘B’ as determined by use of Gardner-Holdt bubble tubes at a temperature of 20° C. At this point a charge of 50% sodium hydroxide solution (aq) (25.0 g) and water (635.0 g) were added to the reactor with continuous stirring.

The temperature of the mixture was adjusted to 75° C. and maintained at this level until the viscosity was a ‘J’ as determined by use of Gardner-Holdt bubble tubes at a temperature of 20° C. At this point a charge of 50% sodium hydroxide solution (aq) (50.0 g) and water (635.0 g) were added to the reactor with continuous stirring.

Again, the temperature of the mixture was adjusted to 75° C. and maintained at this level until the viscosity was a ‘J’ as determined by use of Gardner-Holdt bubble tubes at a temperature of 20° C. At this point the mixture was cooled to a temperature of 20° C. and a charge of 50% sodium hydroxide solution (aq) (71.0 g) was added to the reactor with continuous stirring.

The resulting resin was a clear solution free of volatile solvents. It had a nitrogen content of 0%, a molar ratio of formaldehyde to phenol of 1.50, a density of 1.11 g/mL, a viscosity value of 63 cps, an alkalinity value of 8.6%, a pH value of 11, and a percent solids value of 29.9%.

### Resin I

A 4-liter reactor, which was equipped with heating jacket, cooling coils and reflux condenser, was charged with 90% phenol solution (aq) (6.2 moles, 647.3 g), 91% paraformaldehyde prill (9.3 moles, 306.6 g), water (500.0 g) and 50% sodium hydroxide solution (aq) (9.6 g). The mixture was stirred and heated to a temperature of 85° C. over a period of 20 minutes. The temperature of the mixture was maintained at 85° C. until the viscosity was an ‘A2’ as determined by use of Gardner-Holdt bubble tubes at a temperature of 20° C. At this point a second charge of 50% sodium hydroxide solution (aq) (9.6 g) was added to the reactor and the temperature of the mixture was reduced to 80° C.

The mixture was stirred and the temperature was maintained at 80° C. until the viscosity was an ‘B’ as determined by use of Gardner-Holdt bubble tubes at a temperature of 20° C. At this point a charge of 50% sodium hydroxide solution (aq) (20.0 g) and water (510.0 g) were added to the reactor with continuous stirring.

The temperature of the mixture was adjusted to 77° C. and maintained at this level until the viscosity was a ‘J’ as determined by use of Gardner-Holdt bubble tubes at a temperature of 20° C. At this point a charge of 50% sodium hydroxide solution (aq) (40.0 g) and water (510.0 g) were added to the reactor with continuous stirring.

The temperature of the mixture was adjusted to 77° C. and maintained at this level until the viscosity was a ‘J’ as determined by use of Gardner-Holdt bubble tubes at a temperature of 20° C. At this point a charge of 50% sodium hydroxide solution (aq) (10.0 g) and water (650.0 g) were added to the reactor with continuous stirring.

The temperature of the mixture was adjusted to 77° C. and maintained at this level until the viscosity was a ‘J’ as determined by use of Gardner-Holdt bubble tubes at a temperature of 20° C. At this point a charge of 50% sodium hydroxide solution (aq) (10.0 g) and water (650.0 g) were added to the reactor with continuous stirring.

The temperature of the mixture was adjusted to 75° C. and maintained at this level until the viscosity was a ‘J’ as determined by use of Gardner-Holdt bubble tubes at a temperature of 20° C. At this point the mixture was cooled to a temperature of 20° C. and a charge of 50% sodium hydroxide solution (aq) (36.8 g) was added to the reactor with continuous stirring.

The resulting resin was a clear solution free of volatile solvents. It had a nitrogen content of 0%, a molar ratio of formaldehyde to phenol of 1.50, a density of 1.06 g/mL, a viscosity value of 42 cps, an alkalinity value of 8.6%, a pH value of 11, and a percent solids value of 20.3%.

### EXAMPLE 1

An aliquot of Resin A was subjected to a specific heating process in a distillation apparatus (emissions test). The distillate was collected in five fractions and each of these was assayed for ammonia, formaldehyde, phenol and methanol levels.

### COMPARATIVE A

An aliquot of PD115from Borden Chemical Incorporated, believed to be the novel resin described in U.S. Pat. No. 6,572,804 was also subjected to the emissions test.

### COMPARATIVE B

An aliquot of 70CR66 from the Georgia-Pacific Resins Corporation, which is a conventional surface-layer phenol-formaldehyde resin, was also subjected to the emissions test.

### Emissions Test

All distillations were conducted by use of the following process:

Apparatus & Set Up:

1. A new 3-necked 1-liter round bottom flask was washed with hot water and detergent and then rinsed with acetone. The flask was dried with air before proceeding to the next step.

2. The clean flask was weighed and then charged with resin (5.0 g), deionized water (250.0 g) and Dow-Corning 200 Fluid 200 cs (250.0 g) [obtained from Dow-Corning; Midland, Mich.]. The total mass of the loaded flask was measured.

3. The loaded flask was installed into a fractional distillation apparatus. An oil heating bath was mounted to a stage just beneath the distillation flask. The vertical position of the stage was readily adjusted. The distillation flask was further equipped with a thermal probe, an air purge line, and a motor-driven stirring paddle (100-300 rpm). The stirring rate was sufficient to thoroughly homogenize the contents of the flask and also provided excellent transfer of heat between the flask surface and the oil bath. There was no initial airflow into the flask through the purge line. The oil in the heating bath had an initial temperature of about 23° C. and was agitated with a magnetic stirring bar. A branched joint connected the distillation flask to a condenser. An “upper” addition funnel was mounted directly over the condenser through the branched joint. Two “lower” addition funnels were mounted in series directly beneath the condenser. Receiving vials were placed in a cold water bath (13-15° C.) under the “lower” addition funnels.

4. The side-arm valves on the lower addition funnels were initially kept in an open position.

5. The outlet valve and the side-arm valve on the upper addition funnel were initially kept in a closed position. The upper addition funnel was not initially charged with water.

6. Cold water was circulated through the jacket of the condenser.

Run:

1. The heater beneath the oil bath was turned on at about 100% power and the stirring bar was activated. The temperature of the oil bath and the flask contents were measured and recorded every 2.5 minutes throughout the duration of the run.

2. When the temperature of the oil bath was about 190° to 220° C., the heating power was reduced to about 60-80%. For most samples an attempt was made to maintain the temperature of the oil bath in the range of 210° to 220° C. until the contents of the flask had dehydrated.

3. In all runs the temperature of the flask contents increased to about 101° C. during the first 22 minutes. A temperature of about 101° to 105° C. was spontaneously maintained for an extended period of time. In most runs the first drop of condensate was observed at about 24 to 25 minutes.

4. The rate of condensation for the portion of the run subsequent to collection of the first drop of condensate and prior to the sample dehydration point was about 4 to 5 mL/minute. The appearance of the flask contents was observed and recorded throughout each run.

5. An attempt was made to obtain a collection volume for each distillate fraction of about 60 mL, which required about 15 minutes of run time. When a collection vial had been filled with about 60 mL of distillate, the following steps were used to isolate and secure the fraction. First, the outlet valve of the bottom, lower addition funnel was closed. Second, the collection vial was carefully removed from the cold water bath and wiped dry with a towel. The loaded vial was then weighed in order to determine the amount of distillate collected. The vial was then capped. A fresh collection vial was then labeled, tarred and positioned into the cold water bath beneath the bottom, lower addition funnel. The outlet valve on this lower addition funnel was then opened. The collection time and mass of each fraction were recorded.

6. Eventually, in each run the temperature of the flask contents would begin to rise at a rate of about 1° C./minute. At this point in time cold water (250.0 g) was loaded into the upper addition funnel. The fourth collection vial was replaced with the fifth collection vial, which had an 8-oz volume. The upper addition funnel was capped on top and the side valve was opened. The outlet valve was partially opened in order to yield a flow rate out of the upper addition funnel of about 10-15 mL/minute. The side valves on the lower addition funnels were both closed and the air-inlet valve attached to the distillation flask was opened. The flow of air into the distillation flask was initiated and maintained at about 115 to 120 mL/minute and was gauged by use of a flow meter. When the air was turned on the temperature of the flask contents would immediately begin to increase at a rate of about 8° C./minute. The heater for the oil bath was adjusted to 100% power.

7. The temperature of the flask contents was allowed to rise to a temperature of 220° C. As soon as this critical temperature was reached, the oil bath heater was turned off and the run was stopped on the next 2.5 minute interval. The airflow into the distillation flask and the water flow from the upper addition funnel were both shut off during the final 30 s of each run.

8. At the end of the run the fifth fraction sample was isolated and weighed as previously described. The residual amount of water in the upper addition funnel was measured and this information was used to determine the amount of water from this funnel that had been added to the fifth fraction. The hot oil bath was lowered and moved to another storage location. The distillation flask was isolated from the apparatus. The thermal probe and the stirring paddle were removed from the distillation flask. An attempt was made to leave as much of the flask residue in the distillation flask as possible. Flask content losses were estimated to be less than 1 g. The mass of the distillation flask plus the residue was measured and compared to the initial mass of the fully loaded distillation flask. In this manner we were able to estimate the amount of flask content that was transferred out of the distillation flask during the run. This value was compared to the sum of the collected fractions in order to calculate the yield for the run. All runs had yield values of 97% to 99%.

Collected fractions were quantitatively assayed for ammonia, formaldehyde, phenol and methanol. The phenol and methanol levels were determined by use of HPLC (EPA method 604). The ammonia level was determined by use of EPA method 350.1 (calorimetric indophenol method). The formaldehyde level was determined by a modified version of ASTM D6303 (calorimetric 3,5-diacetyl-1,4-dihydro-lutidine method). Internal recovery studies for these methods demonstrated recovery values that were 100%+/−21% for ammonia, 100%+/−1% for formaldehyde, 100%+/−11% for phenol, and 100%+/−10% for methanol.

TABLE 1
Resin Emission Results*

| | | FORMAL- | | |
|---|---|---|---|---|
| RESIN | AMMONIA | DEHYDE | PHENOL | METHANOL |
| Resin A | 0.02 | 40.4 | 19.8 | 3.63 |
| Borden PD115 | 36.7 | 113 | 0.53 | 3.72 |
| GP 70CR66 | 23.8 | 52.1 | 23.4 | 9.11 |

*Note:
emission results are expressed as milligrams of emission per gram of resin solids.

### Thickness Swell & Internal Bond Experiment ‘A’

Resin ‘B’ was used in conjunction with the green lignocellulosic particles to make OSB panels. Specifically, resin ‘B’ was applied to a mixture of green strands (MC 92%) (predominantly aspen, but also comprised of pine, maple and birch) at a loading level of 9.0% based on the solids content of the resin and the dry mass of the wood. The treated strands were subsequently dried in an oven at a temperature of 85° C. to a moisture content of about 2%. The dried strands were then further treated with slack wax (1.25% load level) and phenol-formaldehyde bonding resin in a laboratory blender [surface layer resin=Georgia-Pacific 70CR66 (4.0% load level); core layer resin=Georgia-Pacific 265C54 (4.0% load level)]. The resulting strands were formed into random mats and hot-pressed for 330 seconds with a platen temperature of 400° F. to yield panels that were 0.78 inches thick. These panels were then sanded on both the top and bottom surfaces to yield panels that were 0.72 inches thick. Wood content was held constant at 35 lb/ft³ for the two panel types, resulting in test panels with an average density of 40.2 lb/ft³ and control panels with an average density of 37.5 lb/ft³ after pressing. This same process was used to make control panels with no resin applied to the strands prior to drying. The same conventional bonding resins were applied to both board types at the same loading levels. The two different board types were equilibrated under conditions of 70° F. and 50% relative humidity for a period of about one-week. Both sample types were then submerged in water for a period of two days and then dried in an oven at a temperature of 85° C. for a period of one day. The thickness swell exhibited by each panel type as a result of this exposure to water was measured and is shown along with internal bond data in Table 2.

TABLE 2
THICKNESS SWELL & INTERNAL BOND DATA

| | Thickness Swelling (%) | | Internal Bond (psi) | | |
|---|---|---|---|---|---|
| | Edge | Center | | Single | Six |
| PANEL | Average | Average | As-Is ¹ | Cycle ² | Cycle ³ |
| Control (no | 20.9 | 8.5 | 26.2 | 5.5 | 2.9 |
| resin applied | | | | | |
| to green | | | | | |
| lignocellulosic | | | | | |
| particles) | | | | | |
| Resin B | 8.7 | 3.0 | 33.0 | 12.8 | 9.5 |
| applied to | | | | | |
| green | | | | | |
| lignocellulosic | | | | | |
| particles | | | | | |

¹ Tested in “as-is” condition.
² Tested dry after one cycle of 30 minutes vacuum pressure soak in 150° F. water, 30 minute soak at atmospheric pressure in 150° F. water, and 15 hours of drying at 180° F. in a forced air oven.
³ Tested dry after six cycles of 30 minutes vacuum pressure soak in 150° F. water, 30 minute soak at atmospheric pressure in 150° F. water, six (6) hours of drying at 180° F. in a forced air oven, 30 minutes vacuum pressure soak in 150° F. water, and 15 hours of drying at 180° F. in a forced air oven.

### Thickness Swell & Internal Bond Experiment ‘B’

Resin ‘C’ was used in conjunction with the green lignocellulosic particles to make OSB panels. Specifically, resin ‘C’ was applied to green southern yellow pine strands (MC=92%) at a loading level of 9.0% based on the solids content of the resin and the dry mass of the wood. The treated strands were subsequently dried in an oven at a temperature of 85° C. to a moisture content of about 2%. The dried strands were then further treated with slack wax (1.25% load level) and phenol-formaldehyde bonding resin in a laboratory blender [surface layer resin=Georgia-Pacific 70CR66 (4.0% load level); core layer resin=Georgia-Pacific 265C54 (4.0% load level)]. The resulting strands were formed into random mats and hot-pressed for 200 second with a platen temperature of 400° F. to yield panels that were 0.500 inches thick. Wood content was held constant at 35 lb/ft³ for the two panel types, resulting in test panels with an average density of 40.9 lb/ft³ and control panels with an average density of 37.8 lb/ft³ after pressing. This same process was used to make control panels with the exception that no resin was applied to the strands prior to drying. The same conventional bonding resins were applied to both board types at the same loading levels. The two different board types were equilibrated under conditions of 70° F. and 50% relative humidity for a period of about one-week. Both sample types were then submerged in water for a period of two days and then dried in an oven at a temperature of 85° C. for a period of one day. The thickness swell exhibited by each panel type as a result of this exposure to water was measured and is shown along with internal bond data in Table 3.

TABLE 3
THICKNESS SWELL & INTERNAL BOND DATA.

| | Thickness Swelling (%) | | Internal Bond (psi) | | |
|---|---|---|---|---|---|
| | Edge | Center | | Single | Six |
| PANEL | Average | Average | As-Is ¹ | Cycle ² | Cycle ³ |
| Control (no | 22.5 | 14.6 | 32.8 | 8.8 | 4.4 |
| resin applied | | | | | |
| to green | | | | | |
| lignocellulosic | | | | | |
| particles) | | | | | |
| Resin C | 8.3 | 5.9 | 44.4 | 20.6 | 12.0 |
| applied to | | | | | |
| green | | | | | |
| lignocellulosic | | | | | |
| particles | | | | | |

¹ Tested in “as-is” condition.
² Tested dry after one cycle of 30 minutes vacuum pressure soak in 150° F. water, 30 minute soak at atmospheric pressure in 150° F. water, and 15 hours of drying at 180° F. in a forced air oven.
³ Tested dry after six cycles of 30 minutes vacuum pressure soak in 150° F. water, 30 minute soak at atmospheric pressure in 150° F. water, six (6) hours of drying at 180° F. in a forced air oven, 30 minutes vacuum pressure soak in 150° F. water, and 15 hours of drying at 180° F. in a forced air oven.

### Thickness Swell & Internal Bond Experiment ‘C’

Resin (either ‘F’, ‘G’, ‘H’ or ‘I’) was used in conjunction with the green lignocellulosic particles to make OSB panels (24″×24″). Specifically, resin (either ‘F’, ‘G’, ‘H’ or ‘I’) was applied to a mixture of green strands (MC=92%) (predominantly aspen, but also comprised of pine, maple and birch) at a loading level of 10.0% based on the solids content of the resin and the dry mass of the wood. The treated strands were subsequently dried in an oven at a temperature of 65° C. to a moisture content of about 2-4%. The dried strands were then further treated with slack wax (1.0% load level) and phenol-formaldehyde bonding resin in a laboratory blender [surface layer resin=Georgia-Pacific 70CR66 (5.0% load level); core layer resin=Dynea BB-7010 (5.0% load level)]. The resulting strands were formed into random mats and hot-pressed for 345 seconds with a platen temperature of 400° F. to yield panels that were 0.72 inches thick. Average panel density was 38.0 lb/ft³ on a dry basis. This same process was used to make control panels with the exception that no resin was applied to the strands prior to drying. The same conventional bonding resins were applied to both board types at the same loading levels. The two different board types were equilibrated under conditions of 70° F. and 50% relative humidity for a period of about one-week. Multiple specimens (1″×1″) were cut from each panel type and subjected to a 7-day thickness swell test (and subsequent redry in a ventilated oven at 85° C. for a period of 24 hours. Multiple specimens (2″×2″) were also cut from each panel type and measured for internal bond strength. In yet another test multiple specimens (2″×2″) were cut from each panel type, subjected to a 7-day soak cycle, and measured for internal bond strength in a wet state. The results of these tests are shown in Table 4.

TABLE 4
Thickness Swelling and Internal Bond Strength Data

| | | Thickness swell (%) | Internal bond | Internal bond |
|---|---|---|---|---|
| | Thickness swell (%) | after soaking | strength (psi) | strength (psi) |
| | after soaking | for 7 days & | in a dry, ‘as- | in a wet state after |
| Panel | for 7 days | drying for 1 day | is’ state | 7 days of soaking |
| CONTROL | 24.7 (3.09) | 14.0 (3.19) | 55.1 (12.7) | 10.7 (8.2) |
| (no resin applied to green | | | | |
| lignocellulosic particles) | | | | |
| Resin F applied to green | 11.5 (1.98) | 1.25 (1.39) | 83.2 (23.7) | 24.0 (16.3) |
| lignocellulosic particles | | | | |
| Resin G applied to green | 12.0 (1.76) | 1.61 (1.46) | 97.1 (18.0) | 36.2 (13.6) |
| lignocellulosic particles | | | | |
| Resin H applied to green | 12.1 (1.41) | 1.57 (1.01) | 116.3 (33.1) | 31.4 (21.1) |
| lignocellulosic particles | | | | |
| Resin I applied to green | 13.7 (1.67) | 2.92 (1.52) | 108.4 (30.2) | 20.8 (15.5) |
| lignocellulosic particles | | | | |

Note:
Each average value is based on measurements from 12 different specimens. Numbers shown in parenthesis are standard deviation values.

As a demonstration of the unique composition of the invented resin, a number of comparative resins were prepared as specified in U.S. Pat. NO. 6,369,171 B2.

### Cyclic Urea Prepolymer

### (From Example 1A in U.S. Pat. No. 6,369,171 B2)

A 2-liter reactor, which was equipped with heating jacket, cooling coil, an addition funnel and reflux condenser, was charged with urea (4.0 moles, 240.0 g), 91% paraformaldehyde prill (8.0 moles, 263.9 g) and water (300 g). The mixture was stirred and heated to a temperature of 50° C. over a period of 17 minutes. The temperature of the mixture was maintained at 50° C. and a 28% ammonium hydroxide solution (aq) (242.8 g) was added to the mixture at a rate of about 4 g/minute for a period of about 60 minutes. During this period the mixture was continuously stirred and maintained at a temperature of about 50° C.

Subsequent to the addition of the ammonium hydroxide solution the mixture was heated to a temperature of 90° C. over a period of 15 minutes. The mixture was continuously stirred and maintained at this temperature for a period of 180 minutes.

The mixture was then cooled to 20° C.

The resin had a density of 1.17 g/mL, a pH value of 7, a viscosity of 32 cps and a percent solids value of 46.8%. The calculated nitrogen content of this resin was 36.25%.

### Cyclic Urea Prepolymer

### (From Example 1D in U.S. Pat. No. 6,369,171 B2)

A 2-liter reactor, which was equipped with heating jacket, cooling coil, an addition funnel and reflux condenser, was charged with urea (4.0 moles, 240.0 g), 91% paraformaldehyde prill (16.0 moles, 527.6 g) and water (300 g). The mixture was stirred and heated to a temperature of 50° C. over a period of 17 minutes. The temperature of the mixture was maintained at 50° C. and a 28% ammonium hydroxide solution (aq) (242.8 g) was added to the mixture at a rate of about 4 g/minute for a period of about 60 minutes. During this period the mixture was continuously stirred and maintained at a temperature of about 50° C.

Subsequent to the addition of the ammonium hydroxide solution the mixture was heated to a temperature of 90° C. over a period of 15 minutes. The mixture was continuously stirred and maintained at this temperature for a period of 180 minutes.

The mixture was then cooled to 20° C.

The resin had a density of 1.20 g/mL, a pH value of 4, a viscosity of 38 cps and a percent solids value of 48.8%. The calculated nitrogen content of this resin was 31.56%.

### GP PF Resin

### (Example 3, Resin ‘A’ in U.S. Pat. No. 6,369,171 B2)

A 2-liter reactor, which was equipped with heating jacket, cooling coil, an addition funnel and reflux condenser, was charged with 90% phenol solution (aq) (3.5 moles, 365.6 g), 91% paraformaldehyde prill (2.5 moles, 81.0 g), water (304 g), cyclic urea prepolymer solution [Example 1A] (297.0 g) and 50% sodium hydroxide solution (aq) (39.5 g). The mixture was stirred and heated to a temperature of 80° C. over a period of 15 minutes. At this point a charge of 50% sodium hydroxide solution (aq) (35.5 g) was added to the reactor with continuous stirring. The temperature of the mixture was maintained at 80° C. by use of the cooling coils and a 37% formalin solution (aq) (348.7 g) was added to the mixture at a rate of about 23 g/minute for a period of about 15 minutes. During this period the mixture was continuously stirred and maintained at a temperature of about 80° C.

The mixture was then heated to a temperature of 98° C. over a period of 10 minutes and was maintained at this elevated temperature for an additional period of 22 minutes. The mixture was then cooled to 20° C.

The resulting resin was a clear solution. It had a calculated nitrogen content of 4.27%, a high molecular weight content of 20.5%, a density of 1.15 g/mL, a viscosity value of 31 cps, an alkalinity value of 6.0%, a pH value of 10, and a percent solids value of 42.5%.

### GP PF Resin

### (Example 4, Resin A, in U.S. Pat. No. 6,369,171 B2)

A 2-liter reactor, which was equipped with heating jacket, cooling coil and reflux condenser, was charged with 90% phenol solution (aq) (4.4 moles, 460.0 g), 91% paraformaldehyde prill (6.2 moles, 204.4 g) and 50% sodium hydroxide solution (aq) (5.2 g). The mixture was stirred and heated to a temperature of 92° C. over a period of 65 minutes, and was then maintained at this temperature for a period of 105 minutes. The mixture was then cooled to a temperature of 50° C. and urea (10.4 g) was added with stirring.

After the urea had dissolved, a large portion the mixture (648.6 g) was transferred into a 2-liter round bottom flask and subjected to rotary distillation at a temperature of 50° C. and under reduced pressure (>31 mm Hg) for a period of about 25 minutes to yield a condensate of about 68.9 g. Methanol (92.1 g) was then added to the resin residue with stirring, which resulted in the final resin product.

The resulting resin was a clear solution, but contained methanol (a volatile solvent) at a level of about 13.7%. It had a calculated nitrogen content of 0.99%, a high molecular weight content of 2.6%, a formaldehyde to phenol molar ratio of 1.41, a density of 1.17 g/mL, a viscosity value of 433 cps, an alkalinity value of 0.5%, a pH value of 6-7, and a percent solids value of 79.6%.

### GP PF Resin

### (Example 4, Resin B, in U.S. Pat. No. 6,369,171 B2)

A 2-liter reactor, which was equipped with heating jacket, cooling coil and reflux condenser, was charged with 90% phenol solution (aq) (4.4 moles, 460.0 g), 91% paraformaldehyde prill (7.6 moles, 250.7 g) and 50% sodium hydroxide solution (aq) (14.3 g). The mixture was stirred and heated to a temperature of 82° C. over a period of 50 minutes, and was then maintained at this temperature for a period of 175 minutes. The mixture was then cooled to a temperature of 50° C. and urea (8.2 g) was added with stirring.

After the urea had dissolved, a large portion the mixture (692.6 g) was transferred into a 2-liter round bottom flask and subjected to rotary distillation at a temperature of 50° C. and under reduced pressure (>31 mm Hg) for a period of about 25 minutes to yield a condensate of about 70.0 g. Methanol (77.7 g) was then added to the resin residue with stirring, which resulted in the final resin product.

The resulting resin was a clear solution, but contained methanol (a volatile solvent) at a level of about 11.1%. It had a calculated nitrogen content of 0.70%, a high molecular weight content of 13.4%, a formaldehyde to phenol molar ratio of 1.73, a density of 1.22 g/mL, a viscosity value of 1441 cps, an alkalinity value of 1.2%, a pH value of 7-8, and a percent solids value of 80.9%.

### GP PF Resin

### (Example 4, Resin C, in U.S. Pat. No. 6,369,171 B2)

A 2-liter reactor, which was equipped with heating jacket, cooling coil and reflux condenser, was charged with 90% phenol solution (aq) (4.4 moles, 460.0 g), 91% paraformaldehyde prill (8.5 moles, 280.2 g) and 50% sodium hydroxide solution (aq) (14.3 g). The mixture was stirred and heated to a temperature of 82° C. over a period of 55 minutes, and was then maintained at this temperature for a period of 155 minutes. The mixture was then cooled to a temperature of 50° C. and urea (8.3 g) was added with stirring.

After the urea had dissolved, a large portion the mixture (721.6 g) was transferred into a 2-liter round bottom flask and subjected to rotary distillation at a temperature of 50° C. and under reduced pressure (>31 mm Hg) for a period of about 65 minutes to yield a condensate of about 78.3 g. Methanol (90.6 g) was then added to the resin residue with stirring, which resulted in the final resin product.

The resulting resin was a clear solution, but contained methanol (a volatile solvent) at a level of about 12.4%. It had a calculated nitrogen content of 0.68%, a high molecular weight content of 2.7%, a formaldehyde to phenol molar ratio of 1.93, a density of 1.21 g/mL, a viscosity value of 1987 cps, an alkalinity value of 1.1%, a pH value of 7-8, and a percent solids value of 83.4%.

### GP PF Resin

### (Example 4, Resin D, in U.S. Pat. No. 6,369,171 B2)

A 2-liter reactor, which was equipped with heating jacket, cooling coil and reflux condenser, was charged with 90% phenol solution (aq) (4.4 moles, 460.0 g), 91% paraformaldehyde prill (11.1 moles, 365.9 g) and 50% sodium hydroxide solution (aq) (14.4 g). The mixture was stirred and heated to a temperature of 82° C. over a period of 55 minutes, and was then maintained at this temperature for a period of 152 minutes. The mixture was then cooled to a temperature of 50° C. and urea (8.4 g) was added with stirring.

After the urea had dissolved, a large portion the mixture (812.7 g) was transferred into a 2-liter round bottom flask and subjected to rotary distillation at a temperature of 50° C. and under reduced pressure (>31 mm Hg) for a period of about 57 minutes to yield a condensate of about 87.3 g. Methanol (103.6 g) was then added to the resin residue with stirring, which resulted in the final resin product.

The resulting resin was a clear solution, but contained methanol (a volatile solvent) at a level of about 12.5%. It had a calculated nitrogen content of 0.62%, a high molecular weight content of 2.7%, a formaldehyde to phenol molar ratio of 2.52, a density of 1.24 g/mL, a viscosity value of 2947 cps, an alkalinity value of 1.0%, a pH value of 7, and a percent solids value of 84.0%.

### GP PF Resin

### (Example 4, Resin A, Sample b, in U.S. Pat. No. 6,369,171 B2)

An aliquot of Georgia-Pacific resin [Example 4, Resin ‘A’] (251.3 g) was combined with an aliquot of Georgia-Pacific cyclic urea prepolymer [Example 1, Resin ‘D’] (10.0 g) in a 1-liter plastic beaker. The mixture was manually stirred until homogenous.

The resulting resin was a clear solution, but contained methanol (a volatile solvent) at a level of about 13.2%. It had a calculated nitrogen content of 0.99%, a high molecular weight content of 4.2%, a formaldehyde to phenol molar ratio of 1.41, a density of 1.17 g/mL, a viscosity value of 293 cps, an alkalinity value of 0.5%, a pH value of 7, and a percent solids value of 76.3%.

Compositional differences between the resins described in U.S. Pat. No. 6,369,171 B2 and the resins of this invention are shown in Table 5.

TABLE 5
Comparison of invented resins and those described in U.S. Pat. No. 6,369,171 B2

| | Volatile | | F/P | High molecular | | | Total |
|---|---|---|---|---|---|---|---|
| | solvent | Nitrogen | molar | weight content | Viscosity | Alkalinity | percent |
| Resin | level (%) | level (%) | ratio | (%) | (cps) | (%) | solids (%) |
| Resin A | 0 | 0 | 1.67 | 15.5 | 132 | 12.2 | 50.8 |
| Resin B | 0 | 0 | 1.50 | 23.3 | 278 | 13.0 | 56.0 |
| Resin C | 0 | 0 | 1.37 | 18.9 | 129 | 6.3 | 45.1 |
| Resin D | 0 | 0 | 1.50 | 30.8 | 89 | 8.5 | 30.9 |
| GP Resin from | 0 | 4.27 | * | 20.5 | 31 | 6.0 | 42.5 |
| U.S. Pat. No. 6,369,171 | | | | | | | |
| B2, Example 3, Resin ‘A’ | | | | | | | |
| GP Resin from | 13.7 | 0.99 | 1.41 | 2.6 | 433 | 0.5 | 79.6 |
| U.S. Pat. No. 6,369,171 | | | | | | | |
| B2, Example 4, Resin ‘A’ | | | | | | | |
| GP Resin from | 11.1 | 0.70 | 1.73 | 13.4 | 1441 | 1.2 | 80.9 |
| U.S. Pat. No. 6,369,171 | | | | | | | |
| B2, Example 4, Resin ‘B’ | | | | | | | |
| GP Resin from | 12.4 | 0.68 | 1.93 | 2.7 | 1987 | 1.1 | 83.4 |
| U.S. Pat. No. 6,369,171 | | | | | | | |
| B2, Example 4, Resin ‘C’ | | | | | | | |
| GP Resin from | 12.5 | 0.62 | 2.52 | 2.7 | 2947 | 1.0 | 84.0 |
| U.S. Pat. No. 6,369,171 | | | | | | | |
| B2, Example 4, Resin ‘C’ | | | | | | | |
| GP Resin from | 13.2 | 0.99 | 1.41 | 4.2 | 293 | 0.5 | 76.3 |
| U.S. Pat. No. 6,369,171 | | | | | | | |
| B2, Example 4, Resin ‘A’, | | | | | | | |
| sample ‘b’ | | | | | | | |

* The F/P molar ratio is difficult to estimate because a portion of the formaldehyde was added to the resin in the form of a cyclic urea prepolymer.

What is claimed is:

1. An aqueous, solvent-free, high molecular weight phenol-formaldehyde resin solution having a nitrogen content of from 0 to 3%, a molar ratio of formaldehyde/phenol of from 1.2 to 3.0, a viscosity of less than 500 cps at 20° C., an alkalinity level of about 5% to 15%, and a percent solids of 10% to 60%.

2. The resin of claim 1 wherein the nitrogen content is from about 0 to 1%.

3. The resin of claim 1 wherein the ratio of formaldehyde/phenol is from about 1.2 to 1.6.

4. The resin of claim 1 wherein the viscosity is from about 50 to 300 cps at 20° C.

5. The resin of claim 1 wherein the alkalinity is from about 6% to 13%.

6. The resin of claim 1 wherein the percent solids is from about 20% to 55%.

7. The resin of claim 1 wherein about 12% to 35% of the solute portion of the phenol-formaldehyde resin will not spontaneously diffuse through a dialysis membrane tube comprised of regenerated cellulose and having a known molecular weight cut-off of 3,500 Da when said membrane tube is immersed in a continuously stirred reservoir of 50/50 wt/wt methanol/water solution at a temperature of 20° C. for a period of five days.

8. An aqueous, solvent-free, high molecular weight phenol-formaldehyde resin solution having a nitrogen content of from 0 to 1%, a molar ratio of formaldehyde/phenol of from 1.2 to 1.6, a viscosity of from about 50 to 300 cps at 20° C., an alkalinity level of about 6% to 13%, and a percent solids of 20% to 55%.

9. The resin of claim 8 wherein about 12% to 35% of the solute portion of the phenol-formaldehyde resin will not spontaneously diffuse through a dialysis membrane tube comprised of regenerated cellulose and having a known molecular weight cut-off of 3,500 Da when said membrane tube is immersed in a continuously stirred reservoir of 50/50 wt/wt methanol/water solution at a temperature of 20° C. for a period of five days.
